(19) United States
(12) Patent Application Publication
(10) Pub. No.: US 2008/0220632 A1
(43) Pub. Date: Sep. 11, 2008

(54) Large dimension electrical connector configured by modular unit sections

(75) Inventor: Chun-Yi Chang, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/074,754

(22) Filed: Mar. 5, 2008

(30) Foreign Application Priority Data
Mar. 6, 2007 (CN) 200720035247.2

(51) Int. Cl. H01R 12/00

(52) U.S. Cl. 439/74

(57) ABSTRACT

The present invention provides a large dimension electrical connector configured by modular unit sections. Specially, each modular unit has a plurality of contacts received therein and includes a plurality of edges that each has a plurality of flanges. The flange of one particular section of the modular unit interconnects with a flange of an adjacent one of the modular unit to form the large dimension electrical connector. In addition, the flanges of two adjacent modular unit connectors are disposed to overlap in a vertical direction and thickness of the two flanges after mated together is equal to the thickness of the large dimension electrical connector.

### BACKGROUND OF THE INVENTION

1. Field of the Invention

Generally, the present invention relates to the art of electrical connectors. Specially, the present invention provides a large dimension electrical connector configured by modular unit connectors that each has connecting portions for joining the sections—the modular unit connectors together.

2. Background of the invention

Generally speaking, a connector to which the present invention is related is interposed between first and second electronic parts or components having contact pads, respectively, to achieve electrical connection between the first and the second electronic components. In the following description, the first and the second electronic components are a printed board and a Large Scale Integrated circuit (LSI), respectively. The connector comprises an insulator provided with a plurality of contact receptacle holes penetrating the insulator in a thickness direction, and a plurality of contacts having elasticity and inserted into and held in the contact receptacle holes, respectively.

However, in the conventional electrical connectors, housings are usually molded by an injected art.

As a result, when the connector is formed, contacts are inserted in a column-row configuration on the housing of the electrical connector. In addition, when the industry trend is to obtain highest quantity of contacts on the electrical connector, the housing of the electrical connector needs receive more terminals therein for getting a better electrical connection and transmitting more signals, number of passageways formed on the housing need be increased correspondingly which leads the housing difficultly to mold or insulative material not fully of moulds.

Heretofore, various electrical connectors have been developed for interconnecting IC package to the Printed Wire Board (PWB). Unfortunately, previous attempts in the forming higher density electrical connector were met with difficulties resulted from uneven distribution of material flow and shrinkages, problems that were magnified as the housing/array of the contacts became larger.

U.S. Pat. No. 6,679,707 issued to Brodsky on Jan. 20, 2004 discloses a modular electrical connector formed from several smaller sections that each includes interconnecting fingers for joining the sections together. Configuring the electrical connector by interconnecting the comparable smaller sections together, an electrical connector having maximum quantity of contacts can be easily provided. Brodsky's skill is a good concept but not an only/most suitable way.

In view of the foregoing, there exists a need for an electrical connector for forming the same that maximizes the contacts thereof.

### SUMMARY OF THE INVENTION

Accordingly, an object of the present invention is to provide a large dimension electrical connector for increasing the number of the contacts thereof.

To achieve the above-mentioned object, in a preferred embodiment of the present invention, the present invention provides a large dimension electrical connector configured by modular unit connectors, wherein each modular unit connector has a plurality of contacts receiving therein. Specially, each modular unit connector includes a plurality of edges that each has a plurality of flanges. The flange of one particular one of the modular unit connectors interconnects with a flange of an adjacent one of the modular unit connectors to form the large dimension electrical connector. In addition, the flanges of two adjacent modular unit connectors are disposed to overlap in a vertical direction and thickness of the two flanges after assembly is equal to the thickness of the large dimension electrical connector.

By forming the large dimension electrical connector in the above manner, a maximum quantity of contacts can be provided and the connector has a good planeness.

### BRIEF DESCRIPTION OF THE DRAFLANGES

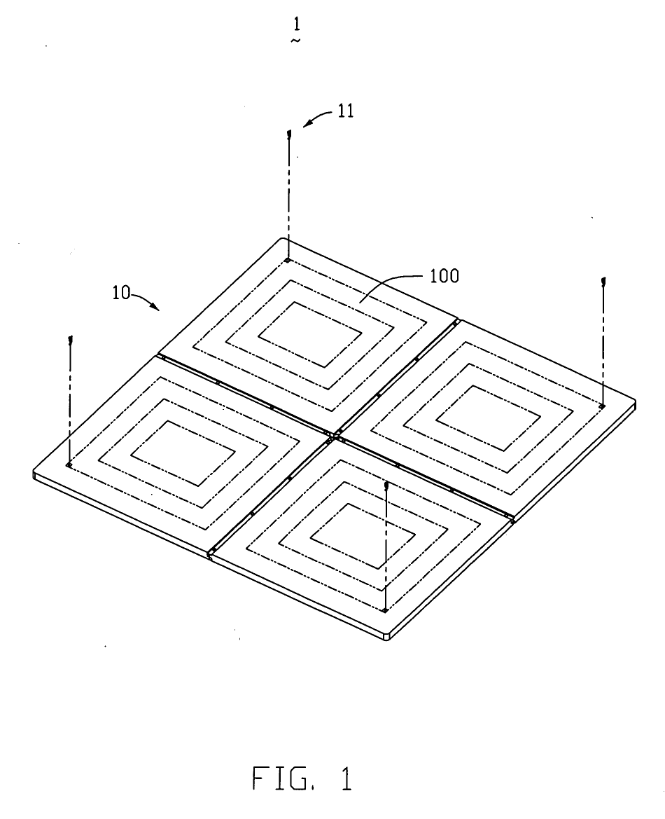

FIG. 1 is an assembled, perspective view of an electrical connector in accordance with a preferred embodiment of the present invention;

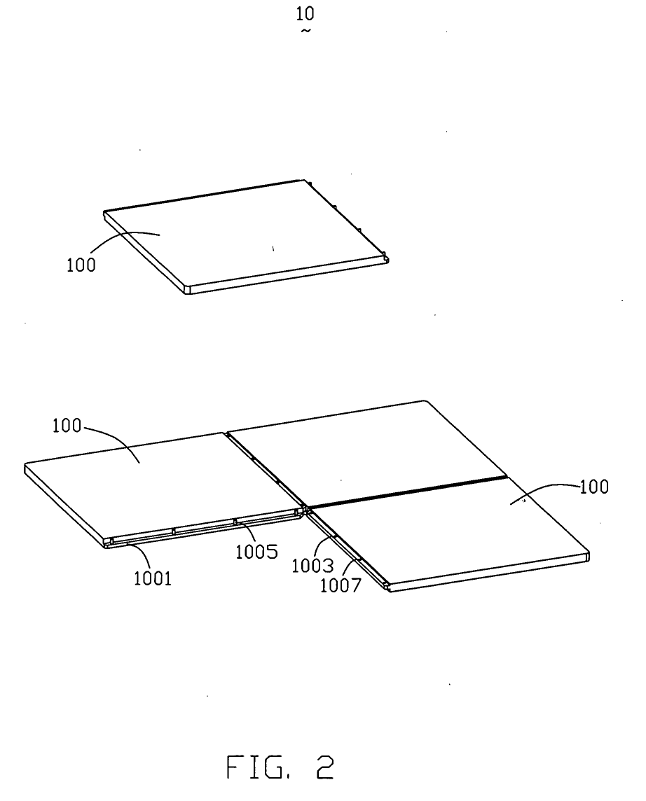

FIG. 2 is a partially exploded view of FIG. 1, wherein one smaller section is individually shown; and

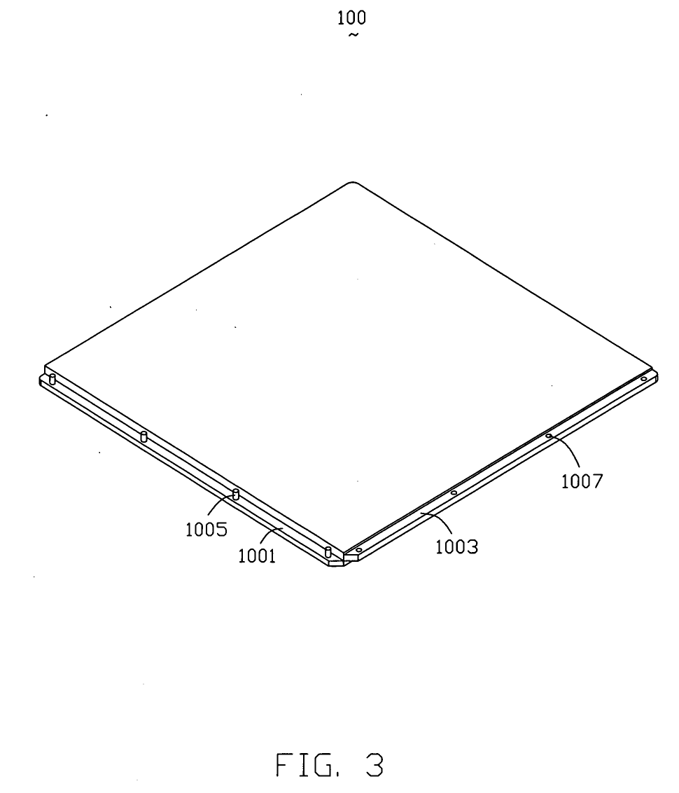

FIG. 3 is an enlarged perspective view of one of small sections in accordance with a preferred embodiment of the present invention.

### DETAILED DESCRIPTION OF THE PREFERRED EMBODIMENT OF THE INVENTION

A preferred embodiment of the present invention will be described hereunder with reference to the accompanying drawings FIG. 1-FIG. 3.

As indicated above, the present invention provides a large dimension electrical connector configured by modular connectors. In other words, the large dimension electrical connector according to the present invention is formed from multiple (e.g., two or four) individual sections. Each section typically has at least one edge that has a flange positioned thereon. Each finger of a particular section interconnects with a flange from a different, adjacent section to form the large dimension electrical connector. Moreover, each of the sections can be formed from a common mold and then to interconnect with each other.

Referring to FIG. 1, an assembly of a large dimension electrical connector 1 according to the present invention is shown. As depicted, the electrical connector 1 includes four modular electrical connector sections 100, and each section 100 has a plurality of electrical contacts 11. Each section 100 can be typically formed from an injected art. The four sections 100 interconnect with one another to form a unitary structure 10. The electrical connector 1 may be formed from multiple sections, at least a pair of sections 100.

Referring now to FIG. 2, one section 100 of the assembly of the electrical connector 1 is detached away from the assembly. Moreover, FIG. 3 shows a detailed structure of one section 100. As shown, the section 100 has at least a pair of edges (not labeled), and the section 100 has a certain thickness.

FIGS. 1-2 show the large electrical connector 1 comprises four sections 100. But to be understood, the electrical connector can be formed from two sections or three or more that four. Particularly, when the large dimension electrical connector 1 of the present invention comprises a pair of sections 100, the pair of sections 100 interconnect with each other to form a unitary structure. The first one of the pair of sections 100 includes an edge defining a first flange extending therefrom that occupies partial thickness of the edge. The second one of the pair of sections includes an edge defining a second flange occupying partial thickness of the edge of the second one of the pair sections. The first and second flanges are overlapping and interconnecting with each other to form a unitary structure, and the thickness of the two flanges added together is equal to the thickness of the electrical connector 1.

Therefore, though applicant has indicated that the large dimension electrical connector 1 may be formed from two sections 100, in fact, the electrical connector formed from four sections is a better choice. Hereunder, the electrical connector 1 comprising four sections will be described in detail.

As shown in FIGS. 1-3, the large electrical connector 1 comprises four sections 100 interconnecting with one another. Each of the four sections comprises at least a pair of edges (not labeled) adjacent to each other and has a certain thickness. Each section 100 comprises two flanges 1001, 1003 that are disposed on two adjacent edges, and wherein the two flanges 1001, 1003 of a particular one of the four sections interconnect with two flanges of a different adjacent one of the four sections.

In addition, one of two flanges (1001, 1003) of a particular one of the four sections 100 is disposed above a flange of the two flanges of an adjacent section of the four sections 100. At the same time, the other one (1003, 1001) of the flanges of said particular one of the four sections 100 is disposed under the other flange of the two flanges of said adjacent section 100.

Two adjacent sections 100 are assembled together by mechanical manner. One section of two adjacent sections defines a plurality of positioning post 1005, while the other section defines a plurality of positioning holes 1007 that are adapted to coordinate with the plurality of posts 1005, so as to interconnect the two adjacent sections. In the assembly process, the posts 1005 are inserted into the holes 1007 and mated together by press fit manner.

According to the preferred embodiment of the present invention, the large dimension electrical connector 1 comprises four individual sections 100, each section having a plurality of contacts 11 received therein. According to the preferred embodiment of the present invention, each section 100 needs to be formed in a particular manner and likewise for two adjacent sections, when the two adjacent sections are interconnecting with each other.

In detail, each section 100 comprises two adjacent edges, each edge defining a flange (e.g., 1001, 1003), respectively. The electrical connector 1 has a thickness after assembled. Said thickness of the connector is equal to the thickness of the edges of each section 100. One flange (e.g. 1001) of the two flanges of one section 100 is disposed in a bottom half portion of the thickness of the edge that said flange is positioned; meanwhile, the other flange (e.g. 1003) of the two flanges of the same section 100 is disposed in an upper half portion of the thickness of the other edges of the two edges.

Accordingly, after two adjacent sections are assembled, the two sections form a unitary one, two adjacent edges of two sections are disposed to overlap in vertical direction and the added thickness of two edges is just equal to the thickness and also equal to the thickness of the connector 1. Therefore, the connector will has a quite flat surface, so to mate with an IC perfectly. And accordingly, better electrical connection between the connector and the IC can be established.

By forming the large dimension electrical connector 1 in above-mentioned manner, maximum quantity of contacts can be provided. And the connector 1 will get a better paleness, because the sections can be formed by common manner and the assembled manner will not occupy any space of the connector 1.

Although the present invention has been described with reference to the accompanying drawings, it is not to be construed as being limited thereto. Various alterations and modifications can be made to the embodiments without in any way departing from the scope or spirit of the present invention as defined in the appended claims. Such modifications and alterations that may be apparent to a person skilled in the art are intended to be included within the scope of this invention as defined in by the accompanying claims.

What is claimed is:

1. A large dimension electrical connector comprising:
at least a pair of unit sections, wherein each of the pair of unit sections has a certain thickness;
wherein the first one of the pair of sections includes an edge, the edge defining a first flange extending therefrom that occupies partial thickness of the edge;
wherein the second one of the pair of sections includes an edge, the edge defining a second flange corresponding to the first flange, the second flange occupying partial thickness of the edge of the second one of the pair of sections;
wherein the first and second flanges overlap and interconnect with each other to form a unitary structure, and the thickness of the two flanges added together is equal to the thickness of the electrical connector.

2. The large dimension electrical connector as claimed in claim 1, further comprising the other two sections, wherein each section directly interconnects with two other adjacent sections.

3. The large dimension electrical connector as claimed in claim 1, wherein each section comprises two sets of flanges that are disposed on two adjacent edges, and wherein at least one of the two sets of flanges of a particular one of the sections interconnects with one of two sets of flanges of a different adjacent sections.

4. The large dimension connector as claimed in claim 3, wherein the electrical connector comprises four sections, and wherein one of two sets of flanges of a particular one of the four sections is disposed above a set of flanges of an adjacent one of the four sections, while the other one of the two sets of flanges of the particular one of the four sections is disposed under a set of flanges of a different adjacent one of the four sections.

5. The large dimension connector as claimed in claim 1, wherein the set of flanges of one section defines a plurality of posts extending from at least one of upper/lower surfaces thereof, and the of flanges of another section defines a plurality of positioning holes coordinating with the plurality of posts, so as to interconnect the two sections.

6. The large dimension connector as claimed in claim 5, wherein in an assembly process, each of the posts is inserted into a particular corresponding holes and mated with the particular hole by a press fit manner.

7. A large dimension electrical connector comprising:
a first section having a first flange;
a second section having a second flange, wherein
the first flange interconnects with the second flange to form an integral structure; and wherein
the first flange and the second flange is disposed to overlap in a vertical direction.

8. The large dimension electrical connector as claimed in claim 7, the first section further comprising a third flange, and wherein the third flange interconnects with a fourth flange of a third section.

9. The large dimension electrical connector as claimed in claim 8, wherein the second section further comprises a fifth flange, and wherein the fifth flange interconnect with a sixth flange of a fourth section.

10. The large dimension electrical connector as claimed in claim 9, wherein the third section further comprises a seventh flange, and wherein the seventy finger interconnects with an eighth finger of the fourth section.

11. The large dimension electrical connector as claimed in claim 10, wherein one of the two flanges of a particular one of the four sections is disposed above a flange of an adjacent one of the four sections, while the other one of the two flanges of the particular one of the four sections is disposed under a flange of a different adjacent one of the four sections.

12. The large dimension electrical connector as claimed in claim 7, wherein the first section defines a first edge and said first flange is formed on said first edge and occupies an upper half portion of a thickness of the first edge, said second section defines a second edge and said second flange is formed on said second edge and occupies a lower half portion of a thickness of the second edge.

13. A large dimension electrical connector comprising:
a plurality of units;
each of said units defines a plurality of sides; and
a plurality of flanges formed along said sides, respectively; wherein
said flanges are alternately arranged at upper and lower levels along said sides, respectively, so that the neighboring two flanges are located at said upper and lower levels, respectively; wherein
complementary interengagement devices are formed on the flanges located at said upper and lower levels, respectively; so that the flange at the lower level can be stacked and combined with another flange of a neighboring unit at the upper level via the complementary interengagement devices; the flange at the upper level can be stacked and combined with another flange of another neighboring unit at a lower level via the complementary interengagement device; whereby
all of said units can be assembled with one another to form a final huge integral structure thereof.

14. The large dimension electrical connector as claimed in claim 13, wherein the an amount of the sides of each of said units are an even number.
